(19) United States
(12) Patent Application Publication
(10) Pub. No.: US 2008/0270571 A1
(43) Pub. Date: Oct. 30, 2008

(54) METHOD AND SYSTEM OF VERIFYING PERMISSION FOR A REMOTE COMPUTER SYSTEM TO ACCESS A WEB PAGE

(76) Inventors: Philip M. Walker, Fort Collins, CO (US); William G. McCollom, Fort Collins, CO (US); Kathy L. Miner, Fort Collins, CO (US); Pulle Srinivas, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/742,539

(22) Filed: Apr. 30, 2007

(51) Int. Cl. G06F 15/16

(52) U.S. Cl. 709/218

(57) ABSTRACT

Methods and systems of verifying permission for a remote computer system to access a web page. At least some of the illustrative embodiments are methods comprising receiving a request from a remote computer to access a web page stored on a server, verifying permission of the remote computer to access the web page without the remote computer system sending a user name and password, and granting the remote computer access to the web page if permission is verified.

### BACKGROUND

Limiting access to web pages, both with respect to viewing the web pages and modifying the web pages, is a cumbersome process. For each web page or series of web pages which a person seeks to view and/or modify for which access is limited, the person is assigned a user name and password which are used to authenticate each new session. In some cases, the passwords automatically expire after a pre-determined amount of time, thus forcing the person to periodically generate and remember a new password periodically. While user names and passwords are not complicated pieces of information, the person may have a user name and password for a host of websites (e.g., banking website, stock trading website, online auction website, electronic travel ticketing website, or warranty registration websites, just to name few), and keeping track of all the varying user names and passwords is difficult. Likewise, the entity providing the web pages has a large administrative burden regarding, for example, assigning user names to new users, assigning and modifying privileges for each user, ensuring login privileges are revoked for users whose no longer have permission to access the web pages.

### BRIEF DESCRIPTION OF THE DRAWINGS

For a detailed description of exemplary embodiments, reference will now be made to the accompanying drawings in which:

FIG. 1 shows a system in accordance with at least some embodiments;

FIG. 2 shows in greater detail a home network server in accordance with at least some embodiments; and

FIG. 3 shows a method in accordance with at least some embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .”

Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

The term “Universal Resource Indicator” or URI shall mean a set of characters (e.g., letters, numbers and symbols) that identify a resource accessible through networking protocols, and the URI also comprises any information that may be included with the information that identifies the resource (e.g., information that identifies the referring page, the search terms to use on the requested page, unsubscribe information, or authentication information, expiration information, information regarding for whom the URI was generated).

### DETAILED DESCRIPTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

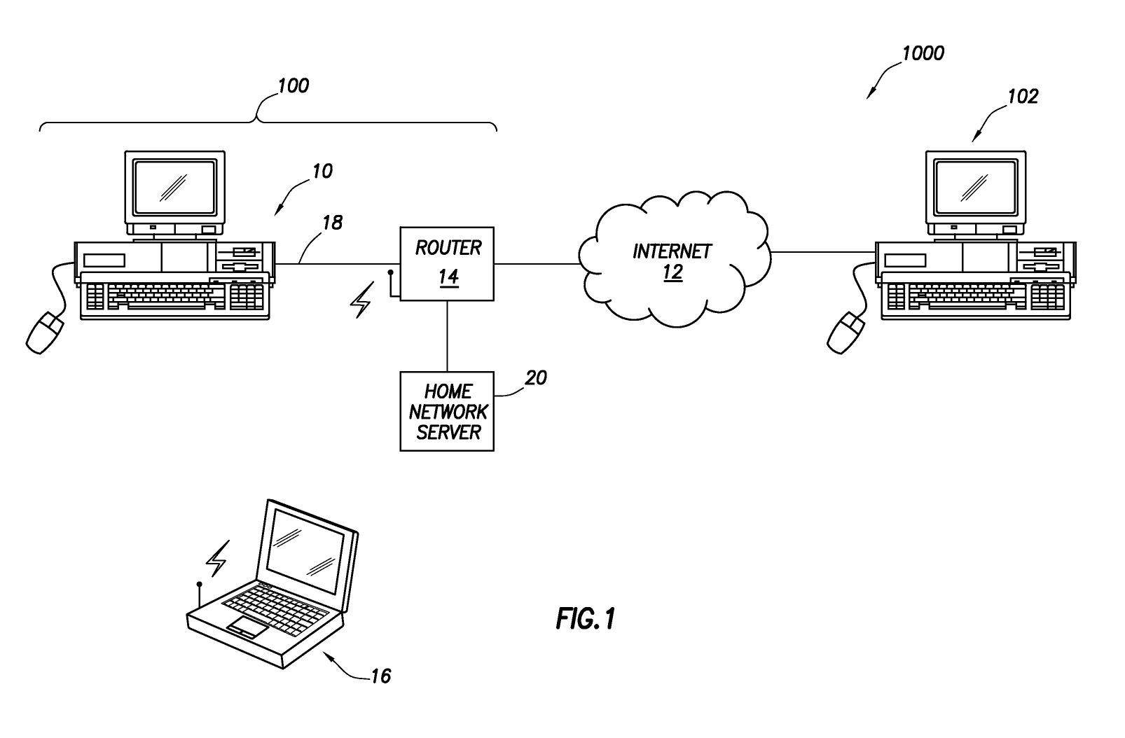

FIG. 1 illustrates a system 1000 in accordance with at least some embodiments. In particular, the system 1000 comprises a home network system 100 and communicatively coupled to a remotely located computer system 102 (i.e., computer system 102 physically located an appreciable distance (e.g., miles) from the home network system). The home network system 100 comprises an illustrative desktop computer system 10 coupled to the Internet 12 by way of a router 14. The home network system 100 also comprises a second computer system, in this case a portable computer system 16, coupled to the Internet 12 by way of the router 14. In the embodiments illustrated in FIG. 1, desktop computer system 10 couples to the router by way of a hardwired connection 18 (e.g., an Ethernet connection) and illustrative portable computer system 16 couples to the router 14 wirelessly (e.g., IEEE 802.11, Bluetooth). However, computer systems may couple to the router in a hardwired fashion and/or wirelessly without regard to their portability. Further, while the home network system 100 of FIG. 1 shows only one desktop computer system 10 and one portable computer system 16, any number of computer systems may be coupled to the router using any networking functionality.

The home network system 100 of FIG. 1 also comprises a home network server 20 coupled to the router 14. The home network server 20 is a storage device and/or server available to any computer system of the home network system 100 (e.g., desktop computer system 10 or portable notebook computer system 16), and in some cases the home network server 20 is also available to the remote computer system 102. The home network server 20 may be, for example, the central repository for data generated by computer systems of the home network system 100 and the server from which family web pages are hosted. The storage implemented by home network server 20 is accessible to other computer systems by way of any suitable currently available networking communication protocol (e.g., Internet Protocol (IP), Transmission Control Protocol/Internet Protocol (TCP/IP), server message block (SMB)/common internet file system (CIFS)), or any after-developed networking protocol. Thus, the home network server 20 operates, at least in part, as a network attached storage (NAS) device.

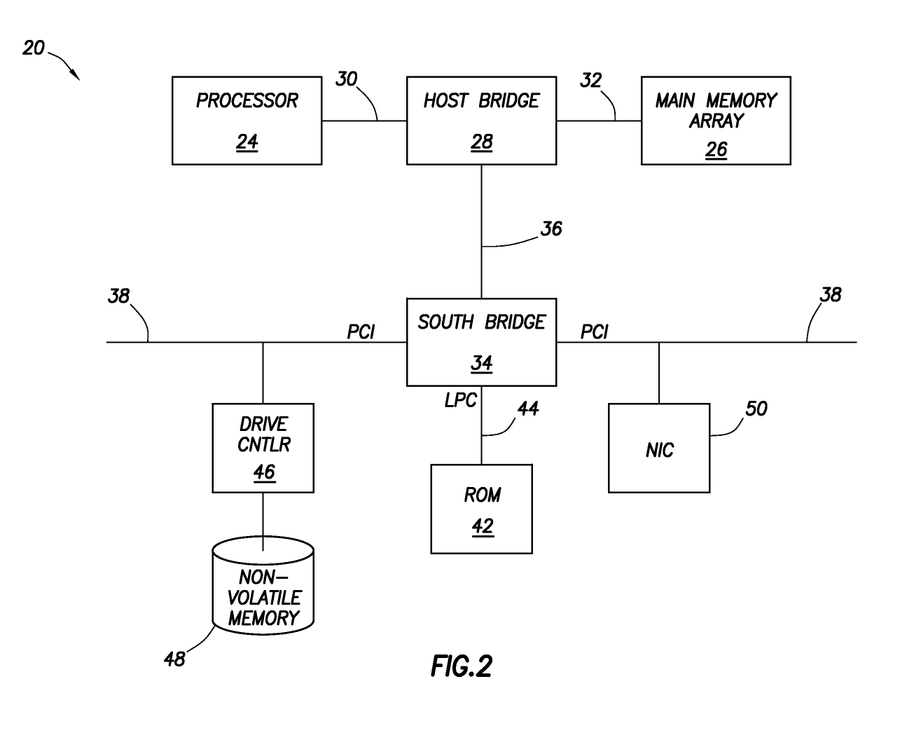

FIG. 2 illustrates in greater detail an embodiment of the home network server 20. In particular, home network sever 20 comprises a processor 24 coupled to a main memory array 26 and various other components through host bridge 28. The processor 24 couples to the host bridge 28 (sometimes referred to as a “north bridge” because of its location in computer system drawings) by way of a host bus 30, or the host bridge 28 may be integrated into the processor 24. The processor 24 may be one of many available processors, and thus the home network server 20 may implement other bus configurations or bus-bridges in addition to, or in place of, those shown in FIG. 2.

Main memory array 26 couples to the host bridge 28 through a memory bus 32. The host bridge 28 comprises a memory control unit that controls transactions to the main memory 26 by asserting control signals for memory accesses. The main memory array 26 functions as the working memory for the processor 24 and comprises a memory device or array of memory devices in which programs, instructions and data are stored. The main memory array 26 may comprise any suitable type of memory such as dynamic random access memory (DRAM) or any of the various types of DRAM devices such as synchronous DRAM (SDRAM), extended data output DRAM (EDODRAM), or Rambus DRAM (RDRAM).

Still referring to FIG. 2, the home network server 20 also comprises a second bridge 34 that bridges the primary expansion bus 36 to various secondary expansion buses, such as the peripheral component interconnect (PCI) bus 38 and the low pin count (LPC) bus 44. The second bridge 34 may be referred to as the “south bridge” because of its location in computer system drawings. Read only memory (ROM) 42 couples to the south bridge 34, such as by the LPC bus 44. The ROM 42 contains software programs executable by the processor 24 to enable the computer system components to perform tasks such as acting as a network attached storage device, and to simplify authentication of access to web pages hosted on the home network server (discussed more below).

The home network server 20 further comprises a drive controller 46 coupled to the south bridge 34 by way of the illustrative PCI bus 38. In alternative embodiments, the drive controller may couple to the primary expansion bus 36, or any other currently available or after-developed expansion bus. The drive controller 46 controls the non-volatile memory 48, such as a hard drive or optical drive. In some embodiments, the home network server 20 implements a single hard drive where computer systems of the home network can store and retrieve data and programs. In alternative embodiments, the home network server 20 implements a redundant array of independent (or inexpensive) devices (RAID) system where the data and instructions written to the home network server are duplicated across multiple hard drives to implement fault tolerance.

Also coupled to the illustrative PCI bus 38 is a network interface card (NIC) 50. In alternative embodiments, the functionality of the NIC 50 is integrated onto the motherboard along with the bridges 28 and 34. Regardless of the precise location where the NIC is implemented, the NIC 50 enables the home network storage 20 to communicate with other computer systems on the home networking system 100 (through the router 14 of FIG. 1) such that the home network server can assist in automatic publishing of user content to web pages.

Because the home network server 20 is designed to act as a server for the home network system 100, and possibly to reduce cost, in accordance with at least some embodiments, the home network server 20 does not support direct coupling of a display device and/or keyboard. Thus, in some embodiments a home network sever 20 does not comprise a graphics controller that would couple to a display, and also does not comprise an input/output (I/O) controller that would couple to I/O devices such as a keyboard and mouse. To the extent administration is performed on the home network server 20, the administration may be accomplished remotely using other computer systems (e.g., desktop computer system 10 or portable computer system 16) in the home network system 100.

In accordance with the various embodiments, the home network server 20 simplifies the process of authenticating access to (i.e., verifying permission to access) web pages hosted on the home network server 20, the simplification both for locally coupled computer systems (e.g., computer systems 10 and 16) and for remotely coupled computer systems (e.g., computer system 102). The discussion from this point forward is based on authenticating access attempts of the remote computer system 102 to view and/or modify web pages hosted on the home network server 20, but the discussion is equally applicable to locally coupled computer systems as well.

Rather than using user various forms of user-supplied information (e.g., names and passwords, and/or biometric information) as the primary mechanism to authenticate access by the remote computer system 102, access to particular web pages hosted by the home network server 20 is based, at least in part, on an invitation process. In order to view a web page (e.g., containing family pictures) hosted on the home network server 20, the home network server 20 is configured to send (e.g., by way of an electronic mail message) to the remote computer system 102 a Universal Resource Indicator (URI) that identifies the web page. In some embodiments, the home network server sends the URI to the remote computer system 102 in the form of a hypertext link in an electronic mail message. For example, the home network server 20 may send an electronic mail message having a hypertext link “http://familypictures.com/Vegas.” Upon activating the link on the remote computer system 102 (e.g., double-clicking the link), a browser program is invoked which searches for and attempts to display the page “http://familypictures.hp.com/Vegas” if available.

While sending URIs from the home network server 20 may dissuade some unauthorized access because of limited knowledge of the domain name and particular web page, “web crawlers” exist on the Internet which systematically scan the Internet for web pages, and make note of the content of identified web pages. Thus, though only a small trusted group of people may receive invitations to view the web pages hosted on the home network server 20, the existence and content of the web pages may nevertheless become known to the general population. In order to at least partially address these concerns, in accordance with at least some embodiments, each URI sent by the home network server 20 contains authentication information. When an access by a remote computer system is attempted, if the URI provided by the remote computer system does not have authentication information, or correct authentication information, then access is denied.

In particular, in accordance with at least some embodiments, each URI generated by the home network server 20 contains an address portion and an authentication portion. The address portion and authentication portion are used to ensure that the URI was generated by the home network server 20. While the authentication portion may take many forms, in some embodiments the authentication portion is created as a one-way hash of the address portion along with other information, such as a private key associated with the home network server 20. One-way hash functions are characterized in that while it is computationally easy to compute the hash value given the source information, it is extremely difficult (e.g., hundreds of computers thousands of hours) to calculate the source information given the hash value and less than all of the source information. A one-way hash may be equivalently referred to as: a compression function; contraction function; message digest; fingerprint; cryptographic checksum; message integrity check (MIC); or manipulation detection code (MDC). Thus, a URI generated in accordance with at least some embodiments may take the illustrative form:
“http://familypictures.com/Vegas&MAC=[HASH VALUE]”
   where “http://familypictures.com/Vegas” is the address portion and “&MAC=[HASH VALUE]” is the illustrative authentication portion calculated using the address portion and other secret information, such as a private key of the home network server 20. In accordance with some embodiments, the hash value is a 32-character string, but any string length may be equivalently used.

When remote computer system 102 attempts to access web pages stored on the home network server 20, the URI provided by the browser of the remote computer system 102 is parsed to extract the address portion and the authentication portion. The home network server 20 calculates the one-way hash of the address portion and the home network server's 20 private key. If the one-way hash created by the home network server 20 using the address portion of the URI and the private key does not match the authentication portion of the URI, then access is denied. For example, a set of pictures from a family vacation to Las Vegas may be posted on the home network server at “http://familypictures.com/Vegas.” If a person has previously been authorized to access other pictures and knows the domain name “familypictures.com,” a person may attempt an unauthorized access to the family's Las Vegas pictures by appending the “/Vegas” to the domain name. While the address portion of the URI provided in the attempted access may indeed identify web pages on the home network server, if no authentication information is included then access is denied by the home network server 20. Likewise, if the URI provided in the attempted access contains an authentication portion that is fabricated or concocted, then the hash value calculated by the home network server 20 in an attempt to authenticate the access will not match, and again access is denied. Authentication based on the URI containing an address portion and an authentication portion thus thwarts those “guessing” web page addresses based on knowledge of the domain name alone, and further thwarts automatic web crawling programs from accessing the web pages.

Having the home network server 20 send invitations to view and/or access web pages, having the home network server 20 send the URI with embedded authentication information, and having the home network server verify the authentication information prior to granting access significantly limits access to the home network server 20 (i.e., secures access to the home network server) without using user names and passwords. In some situations, particularly for web pages hosted on a home network server 20 containing relatively benign information (e.g., family pictures), the level of protection provided may be sufficient. However, for more private information, or for situations where the URIs with embedded authentication information are subject to widespread dissemination (e.g., inadvertently or malicious posting, inadvertent or malicious forwarding of the electronic mail containing the URI to others), further protections may be desirable.

One such protection against inadvertent or malicious dissemination of the URI information is an automatically expiring invitation. In particular, in some embodiments the URI provided by the home network server 20 to the remote computer system 102 expires after a predetermined amount of time (e.g., calculated from generation and sending of the URI, or alternatively from a first use of the URI). During the unexpired period, the URI provided by the home network server 20 may used repeatedly, but after expiration of the predetermined period of time, requests to view the web page identified by the URI are denied. Implementing the expiration of the URI may take many forms. In some embodiments the expiration time is embedded within the URI, either directly or cryptographically. For example, a URI with an embedded expiration time may take the form:
“http://familypictures.com/Vegas&MAC=[HASH VALUE]&EXP=[time]”
   where “http://familypictures.com/Vegas” is the address portion, “&MAC=[HASH VALUE]” is the authentication portion, and “&EXP=[time]” is the expiration portion. The expiration date/time of the URI may be encrypted using the private key of the home network server 20. When authenticating an attempted access, the home network server 20 parses the expiration portion, decrypts the expiration portion using the private key of the home network server 20, and grants access only if the current date is prior to the expiration date. In other embodiments an indication of the person to whom the invitation is directed is embedded within the URI, either directly or cryptographically. For example, a URI with an embedded identification portion may take the form:
“http://familypictures.com/Vegas&MAC=[HASH VALUE] &ID=[user]”
   where “http://familypictures.com/Vegas” is the address portion, “&MAC=[HASH VALUE]” is the authentication portion, and “&ID=[user]” is the identification portion. When authenticating an attempted access, the home network server 20 parses the identification portion, decrypts the identification portion, and thus identifies the person to whom the URI was directed. Once the person is identified, then the home network server can view other information (e.g., a table) to determine if that person's predetermined access period has expired.

Another protection against inadvertent or malicious wide spread dissemination is based the use of HTTP cookies (equivalently referred to as web cookies or just cookies). Cookies are small pieces of data generated by the home network server 20 and provided to the browser of the remote computer system 102 during an initial interaction. During subsequent interactions between the home network server 20 and the browser of the remote computer system 102, the remote computer system 102 provides the cookie, unchanged, to the home network server 20. Such an interaction enables the home network server 20 to determine whether the particular remote computer system 102 has previously interacted with the home network server 20. In the context of authenticating access to the home network server 20, delivery of the cookie to the remote computer system 102 takes place on the initial use of a URI, but not on subsequent uses. Once a URI has been used to access the home network server 20, the URI will be authenticated if the remote computer system 102 can supply the cookie. Thus, even though a malicious attempt to access a web page may use a URI whose authentication portion is consistent with the address portion and the private key of the home network server, if the remote computer system is unable to supply the cookie, access is denied.

In some embodiments, once authenticated the remote computer system 102 has the ability not only to view the web pages, but also to upload data (e.g., pictures) to the home network server 20 for publication on the web pages. For relatively benign data such as family vacation pictures, the inadvertent authentication and viewing by an otherwise unauthorized person is not particularly troublesome. However, when the inadvertent authentication provides for upload ability, the potential for abuse is significant. Thus, yet other protections implemented in at least some embodiments deal with upload parameters. In particular, in some embodiments each user with upload authority is given a certain upload size limitation (e.g., ten megabytes). Once the user has uploaded to his or her quota, no further uploading may occur until approval by the administrator of the home network server 20. In yet other embodiments, the user may upload, but the uploaded data is not published to the web page unless and until approved by the administrator. Thus, for example, the family teenager may be granted access to view and upload pictures to the family web page, but those pictures are not published until, for example, a parent, acting as an administrator, approves the publication. Moreover, the upload size limits and pre-publication approval may be combined in some embodiments.

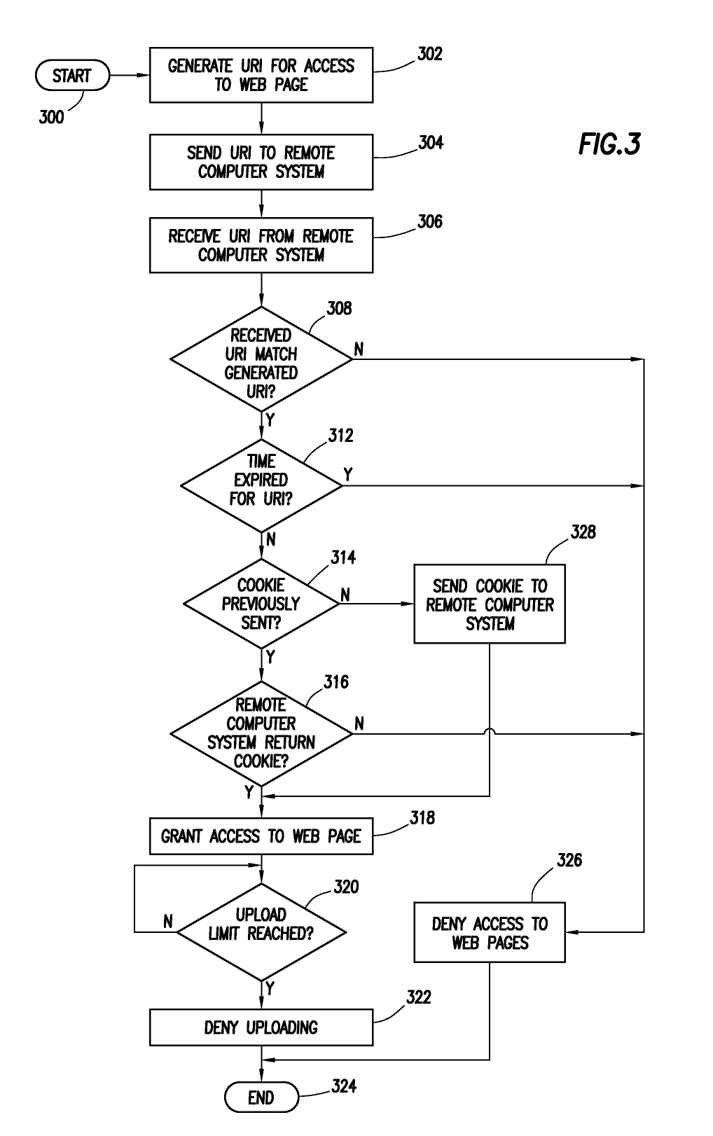

FIG. 3 illustrates a method (e.g., software) in accordance with at least some embodiments. The various method functions of FIG. 3 are merely illustrative, as the particular functions may be equivalently performed in a different order, or some may be omitted. The method starts (block 300) and generates a URI for access to web pages (block 302). Generating the URI may take many forms. In some embodiments, the URI merely comprises an address portion. In other embodiments, the URI comprises the address portion along with an authentication portion. The authentication portion may be any suitable value used to later authenticate that the URI was generated by the server. In some embodiments, the authentication portion is created as the one-way hash of the address portion and a private key of the server. In yet still other embodiments, the URI comprise an expiration portion used to identify a predetermined time within which the URI is usable. In some embodiments, the expiration portion is an expiration time embedded in the URI (e.g., directly embedded or cryptographically modified and then embedded). In other embodiments, the URI comprises an identification portion which identifies for whom the URI was generated. Regardless of the precise form of the URI, the URI is sent to the remote computer system, such as by way of an electronic mail message (block 304).

At some later time, the remote computer system attempts to access web pages using the URI, and thus a URI is received from the remote computer system (block 306). For embodiments that rely solely on the invitation in the form of URI without an authentication portion, access may be immediately granted (block 318), and in which case decisions 312, 314 and 316 would be omitted.

For embodiments where the URI contains an authentication portion, a determination is made as to whether the received URI matches the URI sent (block 308). Determining whether the received and previously sent URIs match may take many forms. In some embodiments the received URI is parsed into the address portion and the authentication portion. A test value is calculated as the one-way hash of the address portion and the private key of the server. In these embodiments, the determination as to whether the sent URI matches the received URI is based on a determination of whether the test value matches the authentication portion.

If the sent URI matches the received URI, in embodiments where the sent URI is only usable for a limited time, a determination is made as to whether a predetermined time for use of the sent URI has expired (block 312). The determination may be made, for example, by inspection of an expiration portion of the URI. In other embodiments, a determination is made as to whom the URI was directed by way of an identification portion of the URI, and the server may consult a table to determine whether a predetermined time for use of the URI by that person has expired.

For embodiments that use cookies as a protection mechanism, the next step in the illustrative method is a determination as to whether a cookie was previously sent to the remote computer system (block 314). If a cookie was previously sent, then the illustrative method moves to a determination of whether the remote computer system returned the cookie in the current attempted access (block 316). If the remote computer system returned the cookie, then access is granted to the remote computer system (block 318). If the access attempt is the first use of the sent URI, then the illustrative process provides a cookie to the remote computer system (block 328), and access is to the web pages is granted (block 318).

Once access to the web pages is granted, in some embodiments upload authority is given, a determination is made as to whether the remote computer system has reached an upload limit (block 320). If the upload limit has not been reached, then the illustrative process loops until the upload limit has been reached (again block 320). Once the upload limit is reached, further uploads by the user are denied (block 322), and the illustrative process ends (block 324).

Returning to the determination of whether the received URI matches the sent URI (block 308), in the event the received URI does not match the sent URI, then access to the web pages is denied (block 326), and the illustrative process ends (block 324). Likewise, if the predetermined time for use of URI has expired (block 312), access to the web pages is denied (block 326), and the illustrative process ends (block 324). Further still, if the cookie has previously been provided, but the remote computer system cannot return the cookie (block 316), access to the web pages is denied (block 326), and the illustrative process ends (block 324).

From the description provided herein, those skilled in the art are readily able to combine software created as described with appropriate general purpose or special purpose computer software to create a computer system and/or computer subcomponents in accordance with the various embodiments, to create a computer system and/or computer subcomponents for carrying out the methods of the various embodiments and/or to create a computer-readable media for storing a software program (e.g., an operating system), to implement the method aspects of the various embodiments.

What is claimed is:

1. A method comprising:
receiving a request from a remote computer to access a web page stored on a server;
verifying permission of the remote computer to access the web page without the remote computer system sending a user name and password; and
granting the remote computer access to the web page if permission is verified.

2. The method according to claim 1 wherein receiving the request further comprises receiving a uniform resource indicator (URI) comprising an authentication value.

3. The method according to claim 1 wherein receiving the request further comprises receiving a uniform resource indicator (URI) having an address portion and the authentication value appended to the address portion.

4. The method according to claim 3 wherein verifying permission further comprises:
separating the address portion from the authentication value;
calculating a test value using the address portion; and
determining if the test value is the same as the authentication value.

5. The method according to claim 4 wherein calculating the test value further comprises calculating the test value using the address portion and a private key associated with the server.

6. The method according to claim 1 wherein receiving the request further comprises receiving a uniform resource indicator (URI) having an authentication value that is a one-way hash of an address portion.

7. The method according to claim 1 wherein receiving the request further comprises receiving a uniform resource indicator (URI) having an authentication value that is a one-way hash of the address portion and a private key of the associated with the server.

8. The method according to claim 1 wherein granting the remote computer access further comprises at least one selected from the group consisting of: granting the remote computer view-only access to the web page; granting the remote computer upload access to the web page; and granting the remote computer upload access to the web page within a predetermined upload size limit.

9. The method according to claim 1 further comprising providing a cookie to the remote computer system if permission is verified to access the web page.

10. The method according to claim 1 further comprising:
receiving a request from a remote computer system to access the web page;
determining whether the request originated from the remote computer system having a cookie previously provided to the remote computer system; and
granting access to the web page if the cookie is present on the remote computer system.

11. The method according to claim 1 further comprising providing the request to the remote computer.

12. The method according to claim 11 wherein verifying permission further comprises determining whether a predetermined amount of time has elapsed since providing the request.

13. The method according to claim 11 wherein providing contents further comprises sending the request to the remote computer system in an electronic mail message.

14. A network server comprising:
a processor; and
a non-volatile memory device coupled to the processor, the non-volatile memory device stores a web page viewable using a web browser; and
wherein the network server is configured to determine whether a remote computer system that requests the web page has permission to access the web page, the determination based on information contained within a Universal Resource Indicator (URI) provided by the remote computer system.

15. The network server according to claim 14 wherein in determining whether the remote computer system has permission to access the web page, the network server is configured to separate the URI into an address portion and an authentication value, calculate a test value using the address portion, and determine if the test value matches the authentication value.

16. The network server according to claim 15 wherein the network server is configured to calculate the test value using the address portion and a private key associated with the network server.

17. The network server according to claim 14 wherein if the remote computer system has permission to access the web page, the network server is configured to at least one selected from the group consisting of: grant the remote computer view-only access to the web page; grant the remote computer upload access to the web page; grant the remote computer upload access to the web page within a predetermined upload size limit; and grant upload access to the web page without publication until approval of administrator of the network server.

18. The network server according to claim 14 wherein the network server is further configured to determine whether the URI originated from the remote computer system having a previously delivered cookie, and grant access to the web page if the cookie is present on the remote computer system.

19. The network server according to claim 14 wherein the network server is further configured to provide the URI to the remote computer system.

20. The network server according to claim 14 wherein the network server, when verifying permission, is further configured to determine whether a predetermined amount of time has elapsed since the URI was provided.

21. The network server according to claim 14 wherein the network server is configured to provide the URI by way of an electronic mail message to the remote computer system.

22. A computer-readable media storing a program that, when executed by a processor, causes the processor to:
generate a first Universal Resource Indicator (URI) comprising a web address portion and an authentication portion;
send the first URI to a remote computer system;
verify that a second URI received from a remote computer system is the same as the first URI.

23. The computer-readable media according to claim 22 wherein when the processor generates the first URI the program causes the processor to:
generate the address portion; and
calculate the authentication portion based on the web address portion and a private key associated with the processor.

24. The computer-readable media according to claim 23 wherein when the processor sends the first URI the program causes the processor to send the first URI by an electronic mail message.

25. The computer-readable media according to claim 23 wherein when the processor calculates the authentication portion, the program further causes the processor to calculate the authentication portion using the address portion and a private key associated with the processor.

26. The computer-readable media according to claim 23 wherein when the processor calculates the authentication portion, the program further causes the processor to calculate the authentication portion comprising a one-way hash of the address portion and a private key.

27. A method comprising:
receiving a request from a remote computer to access a web page stored on a server;
verifying permission of the remote computer to access the web page without the remote computer system sending biometric information of a user; and
granting the remote computer access to the web page if permission is verified.

28. The method according to claim 27 wherein receiving the request further comprises receiving a uniform resource indicator (URI) comprising an authentication value.

29. The method according to claim 27 wherein receiving the request further comprises receiving a uniform resource indicator (URI) having an address portion and the authentication value appended to the address portion.

30. The method according to claim 27 wherein receiving the request further comprises receiving a uniform resource indicator (URI) having an authentication value that is a one-way hash of an address portion.

31. The method according to claim 27 wherein receiving the request further comprises receiving a uniform resource indicator (URI) having an authentication value that is a one-way hash of the address portion and a private key of the associated with the server.

32. The method according to claim 27 wherein granting the remote computer access further comprises at least one selected from the group consisting of: granting the remote computer view-only access to the web page; granting the remote computer upload access to the web page; and granting the remote computer upload access to the web page within a predetermined upload size limit.

33. The method according to claim 27 further comprising providing a cookie to the remote computer system if permission is verified to access the web page.

34. The method according to claim 27 further comprising:
receiving a request from a remote computer system to access the web page;
determining whether the request originated from the remote computer system having a cookie previously provided to the remote computer system; and
granting access to the web page if the cookie is present on the remote computer system.

35. The method according to claim 27 further comprising providing the request to the remote computer.
